(19) United States
(12) Patent Application Publication
(10) Pub. No.: US 2010/0310750 A1
(43) Pub. Date: Dec. 9, 2010

(54) EDIBLE COMPOSITIONS

(76) Inventors: Manjuan Jenny She, Maplewood, MO (US); Dan K. Dixon, St. Louis, MO (US); Mukundan Parthasarathy, Chesterfield, MO (US)

Correspondence Address: WENDELL RAY GUFFEY;NESTLE PURINA PETCARE GLOBAL RESOURCES, INC., 1 CHECKERBOARD SQUARE, 11-T, ST. LOUIS, MO, 63164, US

(21) Appl. No.: 12/735,269

(22) PCT Filed: Dec. 19, 2008
(86) PCT No.: PCT/US08/13869

§ 371 Date: Aug. 20, 2010

Related U.S. Application Data
(60) Provisional application No. 61/009,828, filed on Jan. 2, 2008.

(51) Int. Cl. A23K 1/00; A23L 1/05

(52) U.S. Cl. 426/578; 426/573

(57) ABSTRACT

A composition suitable for use as a feline treat or food containing (1) high melting point fats, (2) humectants, and (3) gelling agents; wherein the composition contains less than about 16% water and has a water activity of about 0.65 or less. The low moisture content means that unwanted microorganisms cannot grow and, thus, eliminates the need for preservatives that lower the palatability. The composition, therefore, has relatively high palatability while retaining its soft texture.

### CROSS REFERENCE TO RELATED APPLICATIONS

This application is a national stage application under 35 U.S.C. §371 of PCT/US2008/008405 filed December 19, which claims priority to U.S. Provisional Application Ser. No. 61/009,828 filed Jan. 2, 2008, the disclosures of which are incorporated herein by this reference.

### BACKGROUND OF THE INVENTION

1. Field of the Invention

The invention relates generally edible compositions and particularly to soft edible compositions suitable for use as an animal food, treat, or snack.

2. Description of the Related Art

Soft foods are very palatable to many animals, particularly pets such as cats. Most soft foods, treats, or snacks have high moisture content. While the high moisture content gives the foods an appealing texture or mouth feel, foods with high moisture are generally subject to microbial growth and spoilage. While it may be desirable to reduce the risk of microbial spoilage by lowering moisture content, it is difficult to sufficiently lower the moisture content of the composition while retaining the desirable soft textural qualities for the composition. Moreover, in the area of snacks foods and pet treats, consumer acceptance is often directly related to the texture. There is, therefore, a need for edible compositions that feature the soft texture provided by foods with a relatively high moisture content while actually having a relatively lower moisture content that reduces or avoids microbial spoilage associated with high moisture content.

### SUMMARY OF THE INVENTION

It is, therefore, an object of the present invention to provide compositions suitable for use as foods, treats, or snacks.

It is another object of the present invention to provide compositions suitable for use as pet treats, including feline treats.

It is another object of the present invention to provide edible compositions that contain reduced amounts of or no added antimicrobials or other preservatives.

It is another object of the present invention to provide methods for manufacturing and formulating soft textured food compositions.

It is a further object of the present invention to provide soft textured food compositions that contain reduced amounts of or no added antimicrobials or other preservatives.

It is a further object of the invention to provide articles of manufacture in the form of kits that contain combinations of compositions and information useful for meeting one or more nutritional requirements of an animal.

One or more of these and other objects are achieved using novel edible compositions comprising one or more high melting point fats, one or more humectants, and one or more gelling agents and having a relatively low moisture content and water activity. The compositions have soft textures similar to compositions with higher moisture content, have improved palatability relative to conventional compositions, and require little or no antimicrobial or other additives that retard spoilage. Other and further objects, features, and advantages of the present invention will be readily apparent to those skilled in the art.

### DETAILED DESCRIPTION OF THE INVENTION

### Definitions

The following abbreviations may be used herein: A_{w} water activity; and HMP, high melting point.

The term “animal” means a human or other animal that can consume the present invention, including avian, bovine, canine, equine, feline, hicrine, lupine, murine, ovine, and porcine animals. Preferred animals include mammals and companion animals. A “companion animal” is any domesticated animal, and includes, without limitation, cats, dogs, rabbits, guinea pigs, ferrets, hamsters, mice, gerbils, horses, cows, goats, sheep, donkeys, pigs, and the like. Dogs and cats are preferred in certain embodiments. In certain embodiments, the term “mammal” includes humans; other embodiments are equally preferred in which humans are specifically excluded.

The term “dietary supplement” means a product that is intended to be ingested in addition to the normal diet of an animal. Dietary supplements may be in any form, e.g. solid, lid, gel, tablets, capsules, powder, and the like. Preferably, dietary supplements are provided in convenient dosage forms. In some embodiments, such supplements are provided in bulk consumer packages such as bulk powders, liquids, gels, or oils. In other embodiments, supplements are provided in bulk quantities to be included in other food items such as snacks, treats, supplement bars, beverages and the like.

The term “food” or “food product” means a product or food composition that is intended for and safe for ingestion by an animal and provides nutrition to the animal. As used herein, a “food product formulated for human consumption” is any composition specifically intended for ingestion by a human being. The term “pet food” or “pet food composition” means a composition intended for consumption by animal, preferably by companion animals. A “complete and nutritionally balanced pet food,” is one that contains all known required nutrients for the intended recipient or consumer of the food, in appropriate amounts and proportions, based for example on recommendations of recognized authorities in the field of companion animal nutrition. Such foods are therefore capable of serving as a sole source of dietary intake to maintain life or promote production, without the addition of supplemental nutritional sources. Nutritionally balanced pet food compositions are widely known and used in the art.

The term “food composition” includes any food, feed, snack, food supplement, treat, meal substitute, or meal replacement, whether intended for a human or other animal. Sometimes such compositions are referred to herein as “dietary compositions.” “Animal food” includes food or feed intended for any domesticated or wild species. In preferred embodiments, a food for an animal represents a nutritionally complete food or dietary composition, for example, a pelleted, extruded, or dry food. Examples of such animal foods include extruded pet foods, such as foods for dogs and cats.

The term “gelling agent” means edible compounds that demonstrate an ability to form a gel in a food under the conditions at which the gelling agent is used. Gelling agents provide foods with texture through formation of a gel. In certain embodiments, without the use of a gelling agent, the food would remain liquid, or free liquid would be present. In other embodiments, without the inclusion of the gelling agent, liquid would separate from the food over time. In yet other embodiments the gelling agent helps to reduce the water activity and thereby reduce the susceptibility of the food to microbial spoilage. Certain gelling agents comprise polysaccharide or protein components. Examples of gelling agents include natural gums, starches, pectins, agars, and gelatin. Specific examples of marine polysaccharides from algae or seaweed include alginic acid, and salts thereof such as sodium, potassium, ammonium, and calcium, agar, and carrageenan. Examples of gums include locust bean gum, xanthan gum, guar gum, gum arabic, gum tragacanth, tara gum and karaya gum. Gelatin is an animal product derived from partially hydrolyzed collagen. Naturally-occurring gelling agents, or those derived from natural sources are preferred for used herein. Aside from providing texture, gelling agents frequently provide functionality during processing of food products, for example, where ingredients would separate, boil out, or lose integrity during cooking, or during storage.

The term “high-melting point fat” or “HMP fat” means an edible fat that does not melt at room temperature, i.e. fats with a melting point above about 25° C. Such fats are typically used to tenderize a product. Examples are lard, hydrogenated animal fat, hydrogenated and vegetable oil. Preferred high-melting point fats are fats that remain solid at room temperature and have melting points that are at least about 40° C. Other useful high melting point fats have melting points greater than about 50° C. Where more than one fat is employed in the compositions, sometimes the average melting point of the fats is referred to. The average melting point of the fats means the weighted average of the fats present. For example if two HMP fat sources are used in equal amounts, HMP fat 1, having a melting point of 40° C., and HMP fat 2, having a melting point of 54° C., the average melting point is 47° C. If the composition has 75% HMP fat 2 and 25% HMP fat I, the average melting point of the HMP fats would be 50.5° C.

The term “humectant” means an edible substance which promotes the retention of moisture in a food. More specifically, humectants are hygroscopic substances or compounds which have a tendency to absorb ambient water, e.g. from the air, or an atmosphere inside a package. Humectants frequently comprise at least one molecule with several hydrophilic substituent groups, such as hydroxyl groups. Humectants can also contain substituents with amines and carboxyl groups, which may be esterified. Humectants are frequently characterized by their ability and affinity for formation of hydrogen bonds with water molecules in the food from the air.

The term “individual” means an individual animal of any species or kind.

The term “microorganism” encompasses at least bacteria, molds and other fungi, and yeasts. The particular microorganisms that will grow in/on foods vary depending on the nature of the food and environment, including pH, temperature, moisture available for growth (e.g. water activity), and the like. While certain microorganisms may result in readily detectable spoilage, the growth of other microorganisms can not be readily detected. Such growth can result in food-borne infection or intoxication and thus represents a threat to an animal consuming the food compositions. Beneficial microorganisms are known in the art and can be included in the formulations of the compositions provided herein.

The term “oral administration” or “orally administering” means that the animal ingests, or a human is directed to feed, or does feed, the animal one or more of the compositions described herein. Wherein a human is directed to feed the composition, such direction may be that which instructs and/or informs the human that use of the composition may and/or will provide a referenced benefit. Such direction may be oral direction (e.g., through oral instruction from, for example, a physician, veterinarian, or other health professional, or radio or television media (i.e., advertisement), or written direction (e.g., through written direction from, for example, a physician, veterinarian, or other health professional (e.g., prescriptions), sales professional or organization (e.g., through, for example, marketing brochures, pamphlets, or other instructive paraphernalia), written media (e.g., internet, electronic mail, web site, or other computer-related media), and/or packaging associated with the composition (e.g., a label present on a container holding the composition), or a combination thereof (e.g. label or package insert with directions to access a website for more information).

The term “regular basis” means at least monthly, more preferably weekly, dosing with or consumption of the compositions. More frequent dosing or consumption, such as twice or thrice weekly are preferred in certain embodiments. Still more preferred are regimens that comprise at least once daily consumption.

The term “single package” means that the components of a kit are physically associated, in or with one or more containers, and considered a unit for manufacture, distribution, sale, or use. Containers include, but are not limited to, bags, boxes or cartons, bottles, packages of any type or design or material, over-wrap, shrink-wrap, affixed components (e.g. stapled, adhered, or the like), or combinations of any of the foregoing. For example, a single package kit may provide containers of individual compositions and/or food compositions physically associated such that they are considered a unit for manufacture, distribution, sale, or use.

The term “snack foods” means food compositions that are intended for ingestion by an animal, and safe for such ingestion. Snack foods, as used herein, are preferably intended to be used to supplement, not replace, meals, and may or may not be formulated to meet all known nutritional needs of the animal. “Pet treats,” which include, for example, cat treats and dog treats, are intended for consumption by an animal that is preferably a companion animal. Like snack foods, pet treats are preferably intended as supplements, not as meal replacements. Pet treats may or may not be formulated to meet all known nutritional needs of the animal. In certain embodiments, pet treats are formulated to provide a certain percentage of an animal's nutritional needs, or they may be formulated to provide additional or supplemental nutritional needs.

The term “substantially free” means that a compound is not intentionally added to a composition in any amount. Moreover, the compound, if present, is present in amounts less than about 10% of the lowest level at which they would typically be added to a food composition to carry out the function for which they are generally added. Preferably, the compound is below any threshold wherein the compound might have to be listed on a label. More preferably, the compound, if present, is present at amounts that fall below the detection limit for a standard analytical detection method for the compound. Most preferably, the compound cannot be detected by any routine method of laboratory analysis.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, view a visual message, or contact a caregiver or instructor to obtain, for example, instructions on how to use the kit, or safety or technical information about one or more components of a kit. Examples of information that can be provided a part of a virtual kit include instructions for use, safety information such as material safety data sheets, poison control information, information on potential adverse reaction, comparative study results, and the like, dietary information such as food composition, or caloric composition, general information on nutrition or nutritional requirements, or general information on treatment nutritional problems or deficits, self-help relating to nutrition, caregiver information for those caring for animals with special or specific nutritional requirements. All percentages for weights expressed herein are by weight of the composition after all components and ingredients are admixed unless expressed otherwise.

Where provided herein, dosages are expressed in milligrams per kilogram of body weight per day (mg/kg/day) unless expressed otherwise.

As used throughout, ranges are used herein in shorthand, so as to avoid having to set out at length and describe each and every value within the range. Any appropriate value within the range can be selected, where appropriate, as the upper value, lower value, or the terminus of the range. Where used herein, the term “about” indicates that the given value, plus or minus 10% is intended. “About” is thus used a shorthand to reflect the recognition that small variations from the literal value stated are still within the scope of the invention.

As used herein and in the appended claims, the singular form of a word includes the plural, and vice versa, unless the context clearly dictates otherwise. Thus, the references “a,” “an,” and “the” are generally inclusive of the plurals of the respective terms. For example, reference to “a puppy,” “a method,” or “a food” includes a plurality of such “puppies,” “methods,” or “foods”. Reference herein, for example to “an antioxidant” includes a plurality of such antioxidants, whereas reference to “pieces” includes a single piece. Similarly, the words “comprise,” “comprises,” and “comprising” are to be interpreted inclusively rather than exclusively. Likewise the terms “include,” “including” and “or” should all be construed to be inclusive, unless such a construction is clearly prohibited from the context. Where used herein the term “examples,” particularly when followed by a listing of terms is merely exemplary and illustrative, and should not be deemed to be exclusive or comprehensive.

The methods and compositions and other advances disclosed herein are not limited to particular methodology, protocols, and reagents described herein because, as the skilled artisan will appreciate, they may vary. Further, the terminology used herein is for the purpose of describing particular embodiments only, and is not intended to and does not limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by the controlling law. The discussion of those references is intended merely to summarize the assertions made therein. No admission is made that any such patents, patent applications, publications or references, or any portion thereof, is relevant, material, or prior art. The right to challenge the accuracy and pertinence of any assertion of such patents, patent applications, publications, and other references as relevant, material, or prior art is specifically reserved. Full citations for publications not cited fully within the specification are set forth at the end of the specification.

### THE INVENTION

In one aspect, the invention provides compositions comprising one or more high melting point (HMP) fats, one or more humectants, and one or more gelling agents. The compositions have a water content of about 16% or less and a water activity of about 0.65 or less. The invention is based upon the discovery that compositions comprising I-IMP fats, humectants, and gelling agents can be made with a texture that is as soft and palatable as compositions having relatively high moisture or water content, e.g., 20% to 35% water content. In addition, because of the low water activity, the compositions of the invention can be formulated with reduced amounts of or without any added antimicrobials or other preservatives. Further, the composition will not spoil because of microorganism growth, even without added antimicrobials or other preservatives. Basically, the compositions are a soft, moist, palatable compositions that will not spoil because of undesirable microorganism growth. The compositions are useful as an edible composition for an animal, e.g. a snack or treat. The compositions can be made according to any method suitable in the art, particularly for food compositions such as snacks or treats.

In a preferred embodiment, the compositions comprise a macronutrient composition suitable for the type of edible composition being designed. In one embodiment, the composition is a human food composition, pet food composition, or a dietary supplement. In one embodiment, the edible composition has about 20% to 32% protein, about 30% to 50% carbohydrate, about 5% to 20% fat, and about 15% to 25% moisture. In another embodiment, the food composition is a pet food composition, for example a premium or super-premium pet food composition. In one embodiment, the pet food is formulated for canines and has a protein content of about 20% to 30%, preferably about 24% to 28%, and more preferably about 25% to 27%. In one embodiment the protein content of a dog food composition is about 26%. In another embodiment, the formulation is for felines and has a protein content of about 35% to 45%, preferably about 37% to 42%, and more preferably about 39% to 41%. In one embodiment the protein content of a cat food composition is about 40%.

In other embodiments, the composition is a food composition comprising on a dry weight basis about 15% to about 50% protein, about 5% to about 40% fat, about 5% to about 10% ash content, and having a moisture content of about 5% to about 16%. In various embodiments, the water content of the composition is about 10% or less. In other embodiments, the water content is 14, 13, 12, 11, 10, 9, 8, 7, 6, or 5%.

The water activity (A_{w}) in the compositions is kept relatively low. In various embodiments, the A_{w} is sufficiently low to reduce or slow microbial growth or spoilage. In other embodiments, A_{w} is low enough to substantially lower microbial growth or spoilage in the compositions. In yet other embodiments, the water activity is low enough to substantially prevent or completely prevent microbial growth or spoilage due to microbial activity. In such embodiments, the food compositions are resistant even to challenges with added microbial loads. In various embodiments, A_{w} is between about 0.65 and 0.6, or between 0.6 and about 0.4. In preferred embodiments, the water activity of the food compositions is between about 0.5 and 0.6. Thus, compositions can be made in accordance with the disclosure herein wherein A_{w} is 0.65, 0.64, 0.63, 0.62, 0.61, or less. Other embodiments feature food compositions with A_{w} of 0.6, 0.59, 0.58, 0.57, 0.56, 0.55, 0.54, 0.53, 0.52, 0.51, or 0.5. Water activity of less than 0.5 is also desirable for certain embodiments, including applications with A_{w} as low as 0.49, 0.48, 0.47, 0.46, 0.45, 0.44, 0.43, 0.42, 0.41 or even 0.4. Lower A_{w} may be achievable or desirable in other embodiments.

In one embodiment, the composition features the addition of humectants at about 10% to about 35%. In certain embodiments, the humectants are present at about 15% to about 25%. The humectants used herein include any of the known humectants used for edible compositions. The use of common humectant ingredients such as sugars (especially available mono- and/or disaccharides), sugar alcohols (such as sorbitol), and polysaccharides (any of a variety of dextrins, maltodextrins, and the like), as well as glycerin, is contemplated herein.

The composition also includes gelling agents, present at about 5% to about 20%. In one embodiment, the gelling agents are present at least about 8%, or more. Preferred gelling agents for certain embodiments herein are starches, modified starches, and gums.

In another aspect, the invention provides compositions that are partially free, substantially free, or completely free of added preservatives or antimicrobial additives. In one embodiment, the compositions are substantially free of propionic acid, calcium silicate, or sorbic acid. The inventive compositions disclosed in another embodiment herein have less than about 0.12% propionic acid, 0.12% calcium silicate, or 0.5% sorbic acid. It is not uncommon for high moisture (20% to 35%) soft-textured compositions to include propionic acid and its salts, calcium silicate, and sorbic acid or its salts at concentrations of 0.125%, 0.125%, and 0.6% respectively. In various embodiments, the compositions disclosed herein contain less than about 0.12, 0.11, 0.10, 0.09, 0.08, 0.07, 0.06, 0.05, 0.04, 0.03, 0.02, or even less than about 0.01, or 0.005% of propionic acid and its salts, or calcium silicate. In other embodiments, the compositions comprising 1-IMP fats, humectants, and gelling agents contain less than 0.6, 0.5, 0.4, 0.3, 0.2, or even less than 0.1 or 0.05% sorbic acid or its salts. In one embodiment, the compositions contain reduce amounts of antimicrobial additives or other preservatives compared to compositions having a relatively higher moisture content, e.g., about 20% to about 35%.

The absence or relative absence of the added preservatives or antimicrobials does not have any deleterious effect on the compositions in terms of their microbial stability. In various embodiments, the food compositions or products made from the compositions will be shelf stable and remain wholesome and fresh, as well as unspoiled and safe from a microbial perspective for periods of 1, 2, 3, or 4 weeks, or even up to 1, 2, 3, 4, 5, 6, 7, 8, 9, 10, 11 or 12 months or more at room temperature. The products will be particularly resistant to spoilage by molds and yeasts as a result of their low water activities.

The edible compositions contain HMP fats, humectants, and gelling agents. In a particular embodiment, the compositions comprise HMP fats at about 18% or less. In others, the HMP fats are present at about 10% or less. In other embodiments, the HMP fats are present at least about 5%. Thus, the compositions may contain a range of HMP fats, encompassing about 20, 19, 18, 17, 16, and 15% HMP fats, in high fat formulations. Other, lower fat formulations of the compositions comprise 14, 13, 12, 11, or 10% HMP fats, or 9, 8, 7, 6, 5% HMP fats. Low fat formulations comprising 4, 3, 2, or at least 1% or 0.5% HMP fat are contemplated for use herein.

The HMP fats are solid at room temperature and therefore have melting points above room temperature. The compositions disclosed herein preferably feature HMP fats with an average melting point greater than about 37° C. or even 40° C. In some embodiments, the HMP fats have an average melting point greater than about 50° C. In various embodiments, the average melting point temperature of the HMP fats is about 30, 35, 36, 37, 38, 39, 40, 41, 42, 43, 44, 45, 46, 47, 48, 49, 50, 51, 52, 53, 54, 55, 56, 57, 58, 59, or even 60° C. or more.

In one embodiment the compositions provided herein are formulated as a feline food composition or a feline treat. Preferably, the composition is shelf stable for at least 6 months at room temperature. In another embodiment, the treats have a soft texture, similar to high moisture feline treats having 20 to 35% moisture content. In such embodiments, the break force, maximum compressive load, as measured using an Instron device, is about 1 pound-force (lbf) or less. In various embodiments the force required for breaking the treat is less than about 2, 1.5, or 1.25 lbf. In other embodiments, the force required is less than about 1.1, 1.0, 0.9, 0.8, 0.7, 0.6, 0.5, or 0.4 lbf.

In another aspect, the invention provides soft-textured feline treat compositions comprising one or more HMP fats, one or more humectants, one or more gelling agents and having a water content of about 16% or less. (As used herein a “cat treat” is suitable for administration to any feline animal and is synonymous with “feline treat”). The treats have a water activity of about 0.65 or less, a maximum compressive break force of about 1 lbf or less, and improved palatability as compared to a conventional soft textured feline treat having a water content of about 20% to about 35%.

Various methods of comparing palatability for food compositions are known. One method suitable for use herein involves presenting the food compositions in a side by side format such that animal can freely select either composition for the duration of the test.

Quite surprisingly, the treats formulated according to the methods disclosed herein have significantly improved palatability as compared to conventional cat treats. The results are shown in the Examples. The improvement is unexpected for several reasons. First, the conventional treats have significantly higher water content, and thus the animals would have been expected to find the conventional treats softer and more palatable. Second, the novel compositions have similar amounts of edible tallow, but substantially less animal hydrolyzate and protein, which might be expected to provide additional palatability, as well as added HMP fats, humectants, and gelling agents. Finally, the HMP fats generally melt above body temperature and would not be expected to provide a considerable boost in palatability. Without limiting the invention to any one theory, the inventors consider that formulating the treats without the preservatives and antimicrobials may have eliminated a negative palatability factor present in the conventional treats. As can be seen in Table 10, based on consumption during the side-by side comparison, the animals preferred the novel treats by a margin of more than 2 to 1, on average, over the conventional or “control” treat formulations.

As discussed for the above compositions, the feline treats comprising HMP fats, humectants, and gelling agents can also be formulated without added antimicrobials or preservatives because of the low water activity. In one embodiment, the treats are substantially free of propionic acid, calcium silicate, or sorbic acid. In one embodiment, the cat treats have less than about 0.12% propionic acid, 0.12% calcium silicate, or 0.5% sorbic acid. High moisture (20 to 35%) soft-textured compositions must include preservatives or antimicrobials such as propionic acid and its salts, calcium silicate, and sorbic acid or its salts. These compounds are typically included in conventional soft-textured treats at concentrations of 0.125%, 0.125%, and 0.6%, respectively. In various embodiments, the feline treats disclosed herein comprise less than about 0.12, 0.11, 0.10, 0.09, 0.08, 0.07, 0.06, 0.05, 0.04, 0.03, 0.02%, or even less than about 0.01%, or 0.005% of propionic acid and its salts, or calcium silicate. In other embodiments of treats comprising HMP fats, humectants, and gelling agents, the treats comprise less than 0.6, 0.5, 0.4, 0.3, 0.2%, or even less than 0.1% or 0.05% sorbic acid or its salts.

It was also unexpected that the treats with so much less water content could be formulated to have comparable texture, as indicated by the maximum compressive load, as the conventional high moisture cat treats. The comparative results of analysis on an Instron device for several novel and conventional compositions are provided herein.

Further, because conventional treats are subject to microbial spoilage and growth due to their moisture content of 20 to 35%, antimicrobial additives or preservatives are required. The inventors found that the novel treats could be formulated to have A_{w} that was low enough to reduce or even eliminate the use of such additives. The treats provided herein also feature reduced or eliminated use of acidulants in the formulation.

Thus, the feline treats exhibit several unexpected properties: (i) treats comprising HMP fats, humectants, and gelling agents can be formulated with significantly reduced water content and yet have a texture that is as soft as conventional treats having 20 to 35% water content; (ii) treats can be formulated to have A_{w} that is substantially lower than that of conventional soft treats, and as a result, the need for preservatives and antimicrobials can be reduced or eliminated; and (iii) treats have statistically improved palatability over the conventional treats, despite their reduced levels of water, animal hydrolyzate, and protein, and the added HMP fats, humectants, and gelling agents.

In one embodiment, the feline treats comprise about 5% to about 10% HMP fats, about 15% to about 25% humectants, about 8% to about 16% gelling agents, about 4% to about 12% water, and a water activity of about 0.50 to about 0.60. The HMP fats have an average melting point of about 50° C. or more, in one embodiment. The humectants can include one or more of glycerin, a monosaccharide, a disaccharide, a sugar alcohol, or a polysaccharide. The gelling agents can include one or more of a modified starch, an agar, a pectin, or an edible gum.

The compositions of the invention are generally well suited for daily, “long term” consumption or administration. “Long term” administration as used herein generally refers to periods of repeated regular consumption in excess of one month. Periods of longer than two, three, or four months are preferred for certain embodiments. Also preferred are more extended periods that include longer than 5, 6, 7, 8, 9, or 10 months. Periods in excess of 11 months or 1 years are also preferred. Longer term encompassing regular or daily use extending over 1, 2, 3 years, or more, without deleterious effect on the health of the animal, is also contemplated herein. Preferably, one or more general or specific health benefits will result from the regular or long-term use of the compositions and treats of the invention.

The compositions of the present invention can thus be administered to an animal (1) in addition to, or in conjunction with, a regular dietary composition or (2) separately, at the same or different frequency or (3) periodically, on a regular or random basis. The compositions may be fed to an animal routinely as appropriate for the particular animal.

In another aspect, the present invention provides methods of manufacturing soft-textured food compositions. The methods comprise admixing one or more high melting point (HMP) fats, humectants, and gelling agents with one or more additional ingredients to provide a mixture; heating the mixture to provide a soft-textured food composition; and forming the food composition to a desired shape and size. In one embodiment, the food composition has a water content of about 16% or less, a water activity of about 0.65 or less, and a maximum compressive break force of about 1 lbf or less. The maximum compressive force or break force is measured using an device capable of measuring such forces. One preferred device is an Instron instrument, which is commonly used in food analysis. In one embodiment, the heating step is conducted in a mixer, and the forming step is conducted in a rotary molding machine. In another embodiment the heating and the forming steps are conducted in an extruder. In other embodiments, the mixture may be formed and then heated (cooked or partially cooked), formed and if needed, heated further (e.g. finished cooking).

In one embodiment, the methods are designed for the manufacture of soft-textured compositions comprising: (i) about 5% to 20% HMP fats, such as 5, 6, 7, 8, 9, 10, 11, 12, 13, 14, 15, 16, 17, 18, 19, or 20%; (ii) about 10% to 35% humectants, preferably about 15, 16, 17, 18, 19, 20, 21, 22, 23, 24, or 25%; (iii) about 5% to 20% gelling agents, for example 5, 6, 7, 8, 9, 10, 11, 12, 13, 14, 15, 16, 17, 18, 19, or 20%; (iv) about 4% to 12% water, including 4, 5, 6, 7, 8, 9, 10, 11, or 12%; and (v) a water activity of about 0.50 to about 0.60 or any intermediate value such as 0.51, 0.52, 0.53, 0.54, 0.55, 0.56, 0.57, 0.58, 0.59, and so on. The HMP fats have an average melting point of about 40° C., 45° C., 50° C. or more, in one embodiment. The humectants can include one or more of glycerin, a monosaccharide, a disaccharide, a sugar alcohol, or a polysaccharide. The gelling agents can include one or more of a modified starch, an agar, a pectin, or an edible gum.

According to certain embodiments, the methods are tailored to produce soft-textured compositions for a high-quality commercial food. As used herein, “high-quality commercial food” refers to a diet manufactured to provide at least 80% digestibility of the key nutrients for an animal. For example, as set forth in the recommendations of the National Research Council above for dogs, or in the guidelines set forth by the Association of American Feed Control Officials. Similar high standards would be used for other animals.

The methods entail admixing the HMP fats, humectants, and gelling agents with one or more additional ingredients. These additional ingredients can comprise protein, fat, carbohydrates, vitamins, or minerals. In one embodiment, the additional ingredients comprise nutrients sufficient for a balanced diet of an animal. Preferably, the animal is a mammal. More preferably the mammal is a companion animal, such as a dog or a cat. In other embodiments that animal is a human, or a nonhuman and noncompanion animal in yet other instances. In a preferred embodiment, the composition can be administered to the animal on a daily basis.

Thus, in one embodiment, the food compositions comprise any of a variety of additional ingredients, or combinations thereof, selected for their contributions to the overall composition. A skilled food technologist may choose from among natural (e.g. plant or plant-derived, animal or animal-derived, and microbial or microbial-derived), and synthetic, ingredients or components. In particular embodiments, the ingredients may include any of the cereal grains and/or fractions or components thereof, meat and meat by-products, fish, shellfish, or other seafood, other animal products or by-products, eggs from any source, vitamins, minerals, salts, sweeteners, fiber, flavoring or other palatants, coloring, and functional ingredients such as emulsifiers, stabilizers, softeners, functional coatings, and the like.

For purposes used herein, various food ingredients are discussed. Any added component of a food compositions is considered an ingredient. Examples include cereals, meat, animal products, dairy products and the like, each of which has their common meaning unless otherwise indicated herein or below. A “cereal” is comprehensive of all plants recognized as “cereal” crops, whether currently used in commercial agriculture or merely known practically or botanically as being a “cereal”. For example, “cereals” includes corn, wheat, rice, barley, sorghum, millet, oats, rye, triticale, buckwheat, fonio, and quinoa. The skilled artisan will appreciate that in a given food composition, it not uncommon to use one or more such cereal products. The term “meat” includes products from any animal, preferably muscle tissues, such as chicken or other poultry, Iamb or sheep, veal or beef, pork. Other “animal products” and “by-products” include “dairy products or by-products” derived from the milk of any mammal species.

Preservatives and antimicrobials are to be avoided where indicated, or kept at minimal concentrations if used in specific embodiments. In particular, preferred methods do not utilize added antimicrobials or preservatives in the manufacture of the compositions. In one embodiment, the soft-textured compositions are substantially free of propionic acid and its salts, calcium silicate, or sorbic acid and its salts. In another embodiment herein the compositions have less than about 0.12% propionic acid or its salts, 0.12% calcium silicate, or 0.5% sorbic acid or its salts. These compounds are included, for example at concentrations of 0.125%, 0.125%, and 0.6%, respectively in conventional soft-textured compositions. In various embodiments, the soft-textured disclosed herein comprise less than about 0.12, 0.11, 0.10, 0.09, 0.08, 0.07, 0.06, 0.05, 0.04, 0.03, 0.02%, or even less than about 0.01%, or 0.005% of propionic acid or its salts, or calcium silicate. In other embodiments, the soft-textured compositions manufactured in accordance herewith comprise less than 0.6, 0.5, 0.4, 0.3, 0.2%, or even less than 0.1% or 0.05% of sorbic acid or its salts.

In one embodiment, the methods are directed to the manufacture of soft-textured food compositions, pet food compositions, or pet treats. Preferably, the food composition is a snack food or pet treat. In one embodiment, the food composition is a feline treat.

In various embodiments, pet food or pet treat compositions comprise from about 15% to about 50% crude protein. The crude protein material may comprise vegetable proteins such as soybean meal, soy protein concentrate, corn gluten meal, wheat gluten, cottonseed, and peanut meal, or animal proteins such as casein, albumin, and meat protein. Examples of meat protein useful herein include pork, lamb, equine, poultry, fish, and mixtures thereof.

The soft-textured compositions may further comprise from about 5% to about 40% total fat. The skilled artisan will appreciate that many sources of vegetable, animal, or microbial fats are available for formulating food compositions. In one embodiment, the source of fat is a plant fat, such as corn, soy, or canola oil, preferably one that is readily-available. In another embodiment, an animal fat, such as tallow, is useful for providing calories from fat, as well as enticing flavor to meat-eating animals. Of course, combinations of any of the foregoing ingredients, such as fats, are known in the art and useful for optimizing the food compositions based on functional properties as well as price and availability.

The soft-textured compositions may further comprise a source of carbohydrate. The compositions may comprise from about 15% to about 60% carbohydrate. Examples of such carbohydrates include grains or cereals such as rice, corn, milo, sorghum, alfalfa, barley, soybeans, canola, oats, wheat, and mixtures thereof. The compositions may also optionally comprise other materials such as dried whey and other dairy by-products.

In some embodiments the ash content of the soft-textured compositions ranges from less than about 1% to more than about 15%. Preferably the ash content is in the range of about 1% to about 10% for most food compositions made in accordance with the instant disclosure.

Within limits set forth herein, the moisture content of the soft-textured food compositions can vary depending on the nature of the composition, provided that the texture remains relatively soft, e.g. having a maximum compressive break force of less than 2, 1.5, or preferably about 1 lbf, or less. In one embodiment, the composition is a complete and nutritionally balanced pet food. In this embodiment, the pet food has a moisture content of about 16% or less, such as a quality “dry food,” as would be recognized by those skilled in the art of pet food formulation and manufacturing. “Dry food” describes pet food that contains a limited moisture content, typically in the range of about 5% to about 15% or 20%, and therefore is frequently presented, for example, as small biscuit-like kibbles. In one preferred embodiment, the compositions have moisture content from about 5% to about 15%. Dry food products, as used herein include a variety of foods of various moisture contents, such that they are relatively shelf-stable and resistant to microbial or fungal deterioration or contamination. Also preferred are dry food compositions which are extruded food products, such as pet foods, or snack foods for either humans or companion animals.

The additional ingredients used in the methods may also comprise at least one fiber source. The term “fiber” includes all sources of “bulk” in the food whether digestible or indigestible, soluble or insoluble, fermentable or nonfermentable. Preferred fibers are from plant sources, including and marine plants, but microbial sources of fiber may also be used herein. A variety of soluble or insoluble fibers may be utilized, as will be known to those of ordinary skill in the art. The fiber source can be beet pulp (from sugar beet), gum arabic, gum talha, psyllium, rice bran, stabilized rice bran, carob bean gum, citrus pulp, pectin, fructooligosaccharide, short chain oligofructose, mannanoligofructose, soy fiber, arabinogalactan, galactooligosaccharide, arabinoxylan, or mixtures thereof. In some embodiments, a gum can serve a dual purpose as both a gelling agent herein, and a source of fiber.

Alternatively, the fiber source can be a fermentable fiber. Fermentable fiber has previously been described to provide a benefit to the immune system of a companion animal. Fermentable fiber or other compositions known to those of skill in the art which provide a prebiotic composition to enhance the growth of probiotic microorganisms within the intestine may also be incorporated into the composition to aid in the enhancement of the benefit provided by the present invention to the immune system of an animal.

Thus, in certain embodiments, prebiotic compounds, or probiotic microorganisms, are also included as additional ingredients in the soft-textured compositions made according to the methods provided herein. Probiotic organisms suitable for use herein include, e.g., Enterococcus, Lactobacillus, Bifidobacterium, or Saccharomyces species. These and other probiotic organisms, in any combination, may be admixed with any of the ingredients of the composition. In preferred embodiments, such organisms are specifically adapted for the gastrointestinal tract of the animal for which the composition or food product is intended to be administered.

The methods can be used to manufacture soft-textured compositions that are specially formulated for the intended recipients or consumers, such as for adult animals, or for older or young animals. For example, a formulation can be prepared, and the ingredients admixed, such that the soft-textured composition is adapted for puppies or kittens, or for active, pregnant, lactating, or senior, or aging, animals. Preferably, such specialized formulations will comprise energy and/or nutritional requirements appropriate for animals at different stages of development or age.

Also useful as additional ingredients for the compositions disclosed herein are water-soluble vitamins such as the B vitamins, as well as vitamin C. B vitamins are particularly useful in certain embodiments. “B vitamins” as used herein refer to vitamins B1 (thiamine), B2 (riboflavin), B3 (aka P or PP) (niacin, including nicotinic acid and/or nicotinamide), B5 (pantothenic acid), B6 (pyridoxine), B7 (aka H) (biotin), B8 (myo-inositol), B9 (aka M or B-c) (folic acid), B12 (cobalamin), or salts, conjugates, or derivatives thereof recognized to, or found to, have B vitamin activity. Combinations of any of the foregoing are also useful herein and are sometimes referred to herein as “mixtures” of B vitamins. Since the vitamin requirements vary for different species, not all of the listed compounds are deemed vitamins for all species. For example, since it is known that myo-inositol can be synthesized by humans, it is no longer deemed a vitamin, as it is not required for adequate human nutrition.

Antioxidants are well known in the art of food technology and food formulation and may be included as additional ingredients in the methods provided herein. Natural antioxidant compounds include vitamins (such as A, C and E, and derivative, conjugates, or analogs thereof), as well as plant extracts, including extracts from fruit, vegetables, herbs, seeds, and other types and/or parts of plants. Compounds such as α lipoic acid, chlorophyll and derivatives thereof, glutathione, ubiquinols (e.g. coenzyme Q10), carotenoids (e.g. lycopene), flavonoids, phenolic acids and polyphenols, and pycnogenol are known to be excellent antioxidants. Some examples of plant sources of antioxidants include those from fruits such as berries (Cherry, blackberry, strawberry, raspberry, crowberry, blueberry, bilberry/wild blueberry, black currant), pomegranate, grape, orange, plum, pineapple, kiwi fruit, and grapefruit; those from vegetables including kale, chili pepper, red cabbage, peppers, parsley, artichoke, Brussels sprouts, spinach, lemon, ginger, garlic, and red beets; those from dry fruits like apricots, prunes, and dates; from legumes including broad beans, pinto beans, soybeans. Also nuts and seeds such as pecans, walnuts, hazelnuts, ground nut, sunflower seeds; cereals such as barley, millet, oats, corn. Many natural antioxidants are also available from a wide variety of spices including cloves, cinnamon, rosemary, and oregano. Less widely known sources of antioxidants include Gingko biloba, and tropical plants such as uyaku, and carica papaya. Antioxidant properties of various teas and green tea, as well as fermented products, such as red wine, have become of great interest in recent years and such would be suitable be use herein. Selenium is an excellent oxygen scavenger and works well, especially with vitamin or related tocopherol compounds. Synthetic dietary antioxidants include butylated hydroxyanisole (BHA) and butylated hydroxytoluene (BHT) which are commonly used in food products. Any of the foregoing, alone or in combination are suited for use herein, as are combinations of natural and synthetic antioxidants.

In various embodiments, the soft-textured compositions comprise still further substances as additional ingredients, such as minerals, other vitamins, salts, functional additives including for example palatants, colorants, or emulsifiers. Minerals that may be useful in such compositions include, for example, calcium, phosphorous, potassium, sodium, iron, chloride, boron, copper, zinc, magnesium, manganese, iodine, selenium and the like. Examples of additional vitamins useful herein include such fat soluble vitamins A, D, E, and K. Inulin, amino acids, enzymes, coenzymes, and the like may be useful to include in various embodiments. In preferred embodiments of the invention, the soft-textured compositions are substantially free of added preservatives and antimicrobial additives.

The methods of manufacture allow for the inclusion in the soft-textured compositions of one or more supplementary substances that promote or sustain general health. Preferred substances may be associated with improved physical or mental health.

In a further aspect, the invention provides methods of formulating soft-textured food compositions. The methods comprise (i) formulating food ingredients to provide a final water content in the food of about 16% or less; (ii) including among the ingredients one or more high melting point (HMP) fats, one or more humectants, and one or more gelling agents, in an amount sufficient to achieve in the food composition a water activity of about 0.65 or less; and (iii) selecting among other ingredients to provide the food composition with one or more desirable properties including flavor, aroma, palatability, nutritional balance for an animal, total protein content, total carbohydrate content, total fat content, total caloric content, vitamin content, mineral content, stability, or shelf-life. The formulated food composition has a soft texture, with a maximum compressive force (breaking force) of about 1 lbf or less required to break the food composition in a suitable measuring instrument, such as an lnstron device.

As with the other compositions disclosed herein, preferably, the food composition so formulated does not comprise any antimicrobial additives. In one embodiment, the method results in a food composition that comprises about 5% to about 10% HMP fats, about 15% to about 25% humectants, about 8% to about 16% gelling agents, about 4% to about 12% water, and a water activity of about 0.50 to about 0.60.

The method preferably results in compositions wherein the HMP fats have an average melting point of about 50° C. or more. The resultant compositions further include (a) humectants, including one or more of glycerin, a monosaccharide, a disaccharide, a sugar alcohol, or a polysaccharide, and (b) gelling agents, including one or more of a modified starch, an agar, a pectin, or an edible gum.

The compositions that result from the formulation method comport with descriptions provided above for the compositions, treats, and soft-textured compositions. The skilled artisan will appreciate that the methods of formulation provided can be readily adapted based on the foregoing description of the edible compositions, treats and methods of manufacture for soft-textured food compositions, in addition to the numerous working examples of formulations according to the method. Tables 3-9 provide actual formulations of different food compositions made in accordance herewith.

The skilled artisan will also appreciate that in formulating the food compositions of the invention, the formulations may vary within the constraints given as to maximum water content, maximum water activity, required ingredients, and required softness. Such variation allows for ample consideration by the formulator of the price and/or availability of certain ingredients in the compositions, as well as the batch to batch variation in the analysis of certain ingredients. Thus, a given food composition or formulation may vary slightly from batch to batch, plant to plant, or even season to season depending on such factors. Notwithstanding such variation in specific ingredients selected for manufacturing a particular batch of a food composition, the overall composition (for example, with respect to macro nutrient analysis such as protein, carbohydrate, fat, fiber, or other components) may be held constant or at least substantially constant, for example in accordance with a label claim, such as a claim or guarantee of a minimum or maximum percent of a particular component.

The skilled formulator will appreciate that any of a combination of HMP fats are available and can used herein together or in blends. The skilled artisan can consider the desired average melting point, and other properties such as mouth feel or texture to select the amounts and types of HMP fats for use herein. Further, the skilled formulator will appreciate that combinations of humectants can be used to ensure that the resultant composition will have the desired qualities and properties, such as A_{w}, sweetness, texture, flavor, mouth feel, and the like. The skilled formulator will also appreciate that any of the known gelling agents from any source can be used for purposes required herein. The addition of the humectants, gelling agents and other ingredients can be adjusted by a skilled formulator to achieve an A_{w} of the desired range or value. The skilled formulator will also be guided by the examples to create additional formulae for edible compositions having the required soft texture, which can be readily assessed in the laboratory.

In another aspect, the invention provides kits comprising, in separate containers in a single package, or in separate containers in a virtual package, as appropriate for the kit component, an edible composition comprising (1) one or more high melting point fats, (2) one or more humectants, and (3) one or more gelling agents. The composition provided in the kit has a water content of about 16% or less and a water activity of about 0.65 or less. The kit also contains at least one of (1) instructions for administering the composition to an animal, (2) instructions for one or more methods of using the composition for the benefit of an animal, (3) information on providing proper nutrition, including the composition, to the animal, (4) information about antimicrobials, or (5) comparative information or test results regarding the composition.

In one preferred embodiment, the edible composition in the kit has a soft texture such that the maximum compressive break force is about 1 lbf or less when measured using an Instron device. In another preferred kit, the edible composition comprises no added antimicrobial additives. The edible composition provided in the kit is preferably formulated for a companion animal, such as a dog or a cat.

In a further aspect, the invention provides a means for communicating information about, or instruction for use of, a composition comprising (1) one or more high melting point fats, (2) one or more humectants, (3) one or more gelling agents. The composition has a water content of about 16% or less and a water activity of about 0.65 or less. The information is about, or the instructions are for, one or more of: (1) instructions for administering the composition to an animal; (2) instructions for one or more methods of using the composition for the benefit of an animal; (3) information on providing proper nutrition, including the composition, to the animal; (4) information about antimicrobials; or (5) comparative information or test results regarding the composition. The means of communicating in various embodiments comprises any of a physical or electronic document, digital storage media, optical storage media, audio presentation, audiovisual display, or visual display containing the information, or instructions, or a combination thereof. In one embodiment, the communication means comprises a displayed web site, visual display kiosk, brochure, product label, package insert, advertisement, handout, public announcement, audiotape, videotape, DVD, CD-ROM, computer readable chip, computer readable card, computer readable disk, USB device, FireWire device, computer memory, or any combination thereof.

These and other aspects of the invention will be further understood by reference to the examples set forth below. The examples are intended to illustrate aspects and embodiments of the invention. As such, the skilled artisan will appreciate that the appended claims are not limited to the embodiments or aspects exemplified below.

### EXAMPLES

Several aspects of the invention can be further illustrated by the following examples. It will be understood that these examples are included merely for purposes of illustration and do not limit the scope of the appended claims unless otherwise specifically indicated.

### Examples 1 through 9

Nine different edible compositions were prepared as soft feline treats and tested for preference in animal panels. Each of the nine formulations (Examples A1-A2 & B1-B7) was made by blending and mixing the ingredients listed in the corresponding tables (Tables 1 to 9), heating the mixtures to 85° C. in a dough mixer, and molding the cooked dough in a rotary molding machine to form into small pieces. These nine foods were divided into two groups: Group A comprised known formulas (Examples A1 to A2) for soft feline treats with high moisture content (20% to 35%) and high water activity (about 0.85); and Group B (Examples B1 to B7) comprised formulas for soft feline treats prepared according to the invention with low moisture content (less than 16%) and low water activity (less than 0.65).

The formulas for the nine compositions are shown in the Tables 1 through 9. Where so indicated in the formula, the ingredient listed as “Halt” refers to a preservative for pet foods comprising a mixture of 50% propionic acid and 50% calcium silicate.

TABLE 1

| | Formula |
|---|---|
| Example 1 | A1 |
| Ingredient | wt. % |
| Protein, Animal or Vegetable | 15.67 |
| Wheat Flour | 10.53 |
| Salt, Iodized | 0.23 |
| Animal Hydrolysate | 23.09 |
| Natural Flavors | 0.20 |
| Vitamins and Minerals | 4.61 |
| Antioxidant | 0.03 |
| Tallow, Edible | 5.80 |
| Water | 24.72 |
| Sorbic Acid* | 0.60 |
| Halt* | 0.25 |
| Acidulant (for pH adjustment) | 2.31 |
| Modified Starch | 6.49 |
| Humectant** | 5.47 |
| Total | 100.00 |

TABLE 2

| Example 2 | Formula A2 |
|---|---|
| Ingredient | wt. % |
| Protein, Animal or Vegetable | 23.46 |
| Wheat Flour | 15.15 |
| Dry Meat Meal | 6.86 |
| Salt, Iodized | 0.85 |
| Animal Hydrolysate | 29.06 |
| Natural Flavors | 0.20 |
| Vitamins and Minerals | 2.32 |
| Antioxidant | 0.01 |
| Tallow, Edible | 5.15 |
| Colorant | 0.60 |
| Water | 8.02 |
| Sorbic Acid* | 0.59 |
| Halt* | 0.25 |
| Acidulant (for pH Adjustment) | 1.65 |
| Humectant** | 5.83 |
| Total | 100.00 |

TABLE 3

| | Formula |
|---|---|
| Example 3 | B1 |
| Ingredient | wt. % |
| Protein, Animal or Vegetable | 12.08 |
| Wheat Flour | 8.12 |
| Salt, Iodized | 0.18 |
| Animal Hydrolysate | 17.80 |
| Natural Flavors | 0.20 |
| Vitamins and Minerals | 3.55 |
| Antioxidant | 0.03 |
| Tallow, Edible | 5.80 |
| Water | 6.91 |
| Acidulant | 0.68 |
| Modified Starch***⁽³⁾ | 10.00 |
| Shortening, Animal or Vegetable***⁽¹⁾ | 9.25 |
| Gum***⁽³⁾ | 1.00 |
| Humectant***⁽²⁾ | 24.40 |
| Total | 100.00 |

TABLE 4

| Example 4 | Formula B2 |
|---|---|
| Ingredient | wt. % |
| Protein, Animal or Vegetable | 12.08 |
| Wheat Flour | 8.12 |
| Salt, Iodized | 0.18 |
| Animal Hydrolysate | 17.80 |
| Natural Flavors | 0.20 |
| Vitamins and Minerals | 3.55 |
| Antioxidant | 0.03 |
| Tallow, Edible | 5.80 |
| Acidulant | 0.68 |
| Modified Starch***⁽³⁾ | 10.00 |
| Shortening, Animal or Vegetable***⁽¹⁾ | 9.25 |
| Gum***⁽³⁾ | 1.00 |
| Humectant***⁽²⁾ | 31.31 |
| Total | 100.00 |

TABLE 5

| | Formula |
|---|---|
| Example 5 | B3 |
| Ingredient | wt. % |
| Wheat Gluten | 0.93 |
| Wheat Flour | 22.67 |
| Dry Meat Meal | 2.60 |
| Salt, Iodized | 0.50 |
| Animal Hydrolysate | 14.40 |
| Natural Flavors | 0.20 |
| Vitamins and Minerals | 2.38 |
| Antioxidant | 0.03 |
| Tallow, Edible | 5.80 |
| Water | 6.91 |
| Modified Starch***⁽³⁾ | 9.33 |
| Shortening, Animal or Vegetable***⁽¹⁾ | 9.25 |
| Gum***⁽³⁾ | 1.00 |
| Humectant***⁽²⁾ | 24.00 |
| Total | 100.00 |

TABLE 6

| | Formula |
|---|---|
| Example 6 | B4 |
| Ingredient | wt. % |
| Protein, Animal or Vegetable | 12.08 |
| Wheat Flour | 8.12 |
| Dry Meat Meal | 6.98 |
| Salt, Iodized | 0.18 |
| Animal Hydrolysate | 13.55 |
| Natural Flavors | 0.20 |
| Vitamins and Minerals | 1.50 |
| Antioxidant | 0.03 |
| Tallow, Edible | 5.80 |
| Water | 6.91 |
| Modified Starch***⁽³⁾ | 10.00 |
| Shortening, Animal or Vegetable***⁽¹⁾ | 9.25 |
| Gum***⁽³⁾ | 1.00 |
| Humectant***⁽²⁾ | 24.40 |
| Total | 100.00 |

TABLE 7

| Example 7 | Formula B5 |
|---|---|
| Ingredient | wt. % |
| Wheat Gluten | 0.93 |
| Wheat Flour | 22.67 |
| Dry Meat Meal | 13.65 |
| Salt, Iodized | 0.62 |
| Animal Hydrolysate | 4.40 |
| Antioxidant | 0.03 |
| Tallow, Edible | 7.00 |
| Colorant | 0.21 |
| Water | 6.91 |
| Modified Starch***⁽³⁾ | 9.33 |
| Shortening, Animal or Vegetable***⁽¹⁾ | 9.25 |
| Gum***⁽³⁾ | 1.00 |
| Humectant***⁽²⁾ | 24.00 |
| Total | 100.00 |

TABLE 8

| | Formula |
|---|---|
| Example 8 | B6 |
| Ingredient | wt. % |
| Wheat Gluten | 0.72 |
| Wheat Flour | 17.41 |
| Dry Meat Meal | 19.49 |
| Salt, Iodized | 0.48 |
| Animal Hydrolysate | 6.38 |
| Antioxidant | 0.03 |
| Tallow, Edible | 7.00 |
| Colorant | 0.16 |
| Water | 6.91 |
| Modified Starch***⁽³⁾ | 7.17 |
| Shortening, Animal or Vegetable***⁽¹⁾ | 9.25 |
| Gum***⁽³⁾ | 1.00 |
| Humectant***⁽²⁾ | 24.00 |
| Total | 100.00 |

TABLE 9

| Example 9 | Formula B7 |
|---|---|
| Ingredient | wt. % |
| Protein, Animal or Vegetable | 12.57 |
| Wheat Flour | 8.12 |
| Dry Meat Meal | 13.68 |
| Salt, Iodized | 0.45 |
| Animal Hydrolysate | 5.43 |
| Vitamins and Minerals | 1.24 |
| Antioxidant | 0.03 |
| Tallow, Edible | 7.00 |
| Colorant | 0.32 |
| Water | 6.91 |
| Modified Starch***⁽³⁾ | 10.00 |
| Shortening, Animal or Vegetable***⁽¹⁾ | 9.25 |
| Gum***⁽³⁾ | 1.00 |
| Humectant***⁽²⁾ | 24.00 |
| Total | 100.00 |

*Preservatives added for shelf-stability of high moisture/water activity product.
**Comprising one or more of glycerin, sorbitol, sugars, or maltodextrins.
***⁽¹⁾High melting point fats;
***⁽²⁾Humectant; and
***⁽³⁾Gelling agent.

### Example 10

Palatability of the Group A (control or “conventional”) foods versus the Group B (test) foods were compared. Eighty four (84) cats were offered both Group A (referred as control) and Group B (referred as test) foods side-by-side, at the same time in a two-bowl feeding test. The methodology allows assessment of palatability/preference. The arrangement of the food offering was randomized as to the placement of the test and control foods on either the right- or left-side bowl. Each test lasted three (3) hours. At the end of the 3-hour feeding test, the amounts of the test and control group foods were automatically recorded for each cat. For each cat, consumption of each of the foods was calculated as percent of the total amount of the two foods eaten. Individual animal consumption data were averaged to determine the overall average consumption (%). Statistical analysis was performed and p-values for differences between the control and test foods were calculated. Results of 8 feeding tests are summarized in Table 10, with statistical significance indicated.

TABLE 10

| | Average | |
|---|---|---|
| Pal. Test | Consumption, % | p-value |
| A1 vs. B1 | 38.3 vs. 61.7 | 0.031 |
| A1 vs. B2 | 35.8 vs. 64.2 | 0.003 |
| A2 vs. B1 | 12.7 vs. 87.3 | <0.001 |
| A2 vs. B3 | 27.8 vs. 72.2 | <0.001 |
| A2 vs. B4 | 35.5 vs. 64.5 | 0.020 |
| A2 vs. B5 | 18.5 vs. 81.5 | <0.001 |
| A2 vs. B6 | 31.1 vs. 68.9 | <0.001 |
| A2 vs. B7 | 35.0 vs. 65.0 | 0.003 |

Referring to Table 10, the results show that cats had significantly higher consumption of the novel soft feline treat formulations of Group B. Unexpectedly, on average cats, ate more than twice as much of the Group B formulations. Moreover, all of the comparative differences were statistically significant, with all of the p-values were less than 0.05. The palatability of the Group B foods was statistically superior.

### Example 11

A texture profile analysis (TPA) was conducted to evaluate the texture of both Group A and Group B foods. TPA was performed using an Instron 5500R Texture Analyzer. 15 samples (individual kibbles) of each formulation were tested. Testing methodology entailed compression of each kibble. A medium-sized T-shaped metal probe was selected for conducting the compression analysis. Maximum load (or break force) was recorded for each sample kibble. The individual kibble data were averaged to determine the mean maximum load/break force. Results were expressed in units of lbf. One lbf is equal to 4.448 N. The TPA testing results for formulations A1, A2, B1, and B2 are provided in Table 11.

TABLE 11

| | Mean MAX. Load/ |
|---|---|
| Product | Break Force (lbf) |
| A1 | 0.45 |
| A2 | 0.91 |
| B1 | 0.50 |
| B2 | 0.72 |

Referring to Table 11, the results show that the surprising fact that the test group formulations of Group B had similar softness as the control group (Group A) formulations. The novel feline foods thus had textures similar to the known feline foods, despite having significantly less moisture content. In addition, although the textures were comparable, the palatability of the Group B formulations was unexpectedly significantly higher than that that of the moister control formulations.

### Example 12

Soft cat treats having formula B1 were analyzed for pH, water activity, moisture, aerobic bacteria, yeast, and mold. At each sampling period, the treats were analyzed for pH, Aw and moisture. At 6 months, the treats were analyzed for Salmonella, aerobic bacteria, yeast, and mold. The soft cat treats were inoculated at 10⁴ cfu/g mold spores containing strains of sorbate-resistant Penicillium spp., Aspergillus spp., and xerotolerant Eurptoium spp. The inoculated treats were analyzed to determine the initial mold inoculum level. One hundred eighty (180) inoculated samples (50 grams per package) were packaged in a high barrier foil pouch. The treats were stored at room temperature for 6 months. At each sampling point (2, 4, and 6 months), 30 bags of inoculated treats were opened and observed for mold spoilage. When no mold was observed, a sample was analyzed for a viable mold count. The results are shown in Tables 12, 13, and 14.

TABLE 12
Uninoculated Mold Challenge Data

| Sampling Intervals | Total Plate Count | Mold | Yeast | Salmonella |
|---|---|---|---|---|
| (months) | (cfu/g)^{a} | (cfu/g) | (cfu/g) | Per 25 g |
| Initial | 1.7 × 10² | <10 | <10 | Not Tested |
| 6 | 2.7 × 10² | <10 | <10 | Negative |

^{a}cfu/g—colony forming units per gram of product.

TABLE 13
Inoculated Mold Challenge Data

| Sampling | | # spoiled samples/ |
|---|---|---|
| Intervals | Mold Count | # total samples |
| (months) | (cfu/g)^{a} | observed |
| Initial | 1.7 × 10⁴ | — |
| | 1.6 × 10⁴ | |
| 2 | 4.4 × 10³ | 0/30 |
| 4 | 4.8 × 10³ | 0/30 |
| 6 | 4.0 × 10³ | 0/30 |

^{a}cfu/g—colony forming units per gram of product.

TABLE 14
Chemical Analysis

| Sampling | | | |
|---|---|---|---|
| Interval | | Aw | |
| (months) | pH | (Decagon) | Moisture % |
| Initial | 5.80 | 0.566, 0.564 | 12.0 |
| 2 | 5.71 | 0.577, 0.573 | 12.1 |
| 4 | 5.66 | 0.571, 0.568 | 11.8 |
| 6 | 5.76 | 0.565, 0.567 | 11.7 |

^{a}Not Tested

Referring to Tables 12, 13, and 14, the data show that the product has an average pH of 5.7, 12% moisture (Karl Fischer), and 0.57 water activity. The initial inoculated product mold count of 10⁴ cfu/g dropped half a log after two months and is static at 6 months (mid 10³ cfu/g). The product has no visible mold spoilage after 6 months storage.

In the specification, there have been disclosed typical preferred embodiments of the invention and, although specific terms are employed, they are used in a generic and descriptive sense only and not for purposes of limitation, the scope of the invention being set forth in the claims. Many modifications and variations of the invention are possible and would be apparent to a skilled artisan in light of the above teachings. It is therefore to be understood that within the scope of the appended claims aspects of the invention may be practiced otherwise than as specifically described.

1. A composition comprising (1) one or more high melting point (HMP) fats, (2) one or more humectants, and (3) one or more gelling agents; the composition having a water content of about 16% or less and a water activity of about 0.65 or less.

2. The composition of claim 1 wherein the water content is about 10% or less.

3. The composition of claim 1 wherein the water activity is between about 0.6 and about 0.4.

4. The composition of claim 1 wherein the humectants are present at about 10% to about 35%.

5. The composition of claim 1 wherein the humectants are present at about 15% to about 25%.

6. The composition of claim 1 wherein the gelling agents are present at about 5% to about 20%.

7. The composition of claim 1 wherein the gelling agents are present at about 8% or more.

8. The composition of claim 1 that is substantially free of added preservatives.

9. The composition of claim 1 that is substantially free of antimicrobial additives.

10. The composition of claim 1 that is substantially free of propionic acid, calcium silicate, or sorbic acid.

11. The composition of claim 1 having less than about 0.12% propionic acid, 0.12% calcium silicate, or 0.5% sorbic acid.

12. The composition of claim 1 having less than about 0.7% propionic acid, 0.7% calcium silicate, or 0.3% sorbic acid.

13. The composition of claim 1 wherein the HMP fats are present at about 18% or less.

14. The composition of claim 1 wherein the HMP fats are present at about 10% or less.

15. The composition of claim 1 wherein the HMP fats are present at least about 5%.

16. The composition of claim 1 wherein the HMP fats have an average melting point greater than about 40° C.

17. The composition of claim 1 wherein the HMP fats have an average melting point greater than about 50° C.

18. The composition of claim 1 wherein the humectants include one or more of glycerin, a sugar, a sugar alcohol, or a polysaccharide.

19. The composition of claim 18 wherein the sugar alcohol is sorbitol.

20. The composition of claim 18 wherein the polysaccharide is a maltodextrin.

21. The composition of claim 1 wherein the composition is a feline food composition or a feline treat.

22. The composition of claim 21 wherein the composition is shelf stable for at least 6 months at room temperature.

23. The composition of claim 1 wherein the treat has maximum compressive load, as measured using an Instron device, of about 1 lbf or less.

24. The composition of claim 1 formulated as a human food composition, pet food composition, or a dietary supplement.

25. A soft-textured feline treat comprising one or more HMP fats, one or more humectants, one or more gelling agents, and a water content of about 16% or less, the feline treat having a water activity of about 0.65 or less, a maximum compressive break force of about 1 lbf or less, and improved palatability as compared to a soft textured feline treat having a water content of about 20% to about 35%.

26. The feline treat of claim 24 that comprises less than 0.12% propionic acid, 0.12% calcium silicate, and 0.5% sorbic acid.

27. The feline treat of claim 25 that is substantially free of added antimicrobials additives.

28. The feline treat of claim 26 that comprises about 5% to about 10% HMP fats, about 15% to about 25% humectants, about 8% to about 16% gelling agents, about 4% to about 12% water, and a water activity of about 0.50 to about 0.60.

29. The feline treat of claim 24 wherein the HMP fats have an average melting point of about 50° C. or more.

30. The feline treat of claim 24 wherein the humectants include one or more of glycerin, a monosaccharide, a disaccharide, a sugar alcohol, or a polysaccharide.

31. The feline treat of claim 24 wherein the gelling agents include one or more of a modified starch, an agar, a pectin, or an edible gum.

32. A method for manufacturing soft-textured food compositions comprising:
admixing one or more high melting point (HMP) fats, humectants, and gelling agents with
one or more additional ingredients to provide a mixture;
heating the mixture to provide a soft-textured food composition; and
forming the food composition to a desired shape and size;
the food composition having a water content of about 16% or less, a water activity of about 0.65 or less, and a maximum compressive break force of about 1 lbf or less, when measured using an Instron device.

33. The method of claim 32 wherein the heating step, the forming step, or both are conducted in an extruder, a mixer, or a rotary molder.

34. The method of claim 32 wherein the one or more additional ingredients comprise protein, fat, carbohydrates, vitamins, or minerals.

35. The method of claim 34 wherein the additional ingredients comprise nutrients sufficient for a balanced diet of an animal.

36. The method of claim 35 wherein the animal is a mammal.

37. The method of claim 36 wherein the mammal is a companion animal.

38. The method of claim 37 wherein the companion animal is a dog or a cat.

39. The method of claim 32 wherein the food composition is a snack food or pet treat.

40. The method of claim 39 wherein the food composition is a feline treat.

41. The method of claim 32 wherein the HMP fats are present at about 18% of the food composition, or less.

42. The method of claim 41 wherein the HMP fats are present at about 10% of the food composition, or less.

43. The method of claim 41 wherein the HMP fats are present at least about 5% of the food composition.

44. The method of claim 32 having a water content of about 10% of the food composition, or less.

45. The method of claim 32 wherein the water activity of the food composition is between about 0.6 to about 0.4.

46. The method of claim 32 wherein the humectants are present at about 10% to about 35%, of the food composition.

47. The method of claim 46 wherein the humectants are present at about 15% to about 25%, of the food composition.

48. The method of claim 32 wherein the gelling agents are present at about 5% to about 20%, of the food composition.

49. The method of claim 48 wherein the gelling agents are present at about 8% of the food composition, or more.

50. The method of claim 32 wherein the food composition is substantially free of added preservatives.

51. The method of claim 32 wherein the food composition is substantially free of antimicrobial additives.

52. The method of claim 32 wherein the food composition is substantially free of propionic acid, calcium silicate, or sorbic acid.

53. The method of claim 32 wherein the food composition comprises less than about 0.12% propionic acid, 0.12% calcium silicate, or 0.5% sorbic acid.

54. The method of claim 53 wherein the food composition comprises less than about 0.07% propionic acid, 0.07% calcium silicate, or 0.3% sorbic acid.

55. The method of claim 32 wherein the HMP fats have an average melting point greater than about 40° C.

56. The method of claim 32 wherein the HMP fats have an average melting point greater than about 50° C.

57. The method of claim 32 wherein the humectants include one or more of glycerin, a sugar, a sugar alcohol, or a polysaccharide.

58. The method of claim 57 wherein the sugar alcohol is sorbitol.

59. The method of claim 57 wherein the polysaccharide is a maltodextrin.

60. The method of claim 32 wherein the composition is shelf stable for at least 6 months at room temperature.

61. A method of formulating soft-textured food compositions comprising:
formulating food ingredients to provide a final water content in the food of about 16% or less;
including among the ingredients one or more high melting point (HMP) fats, one or more humectants, and one or more gelling agents, in an amount sufficient to achieve in the food composition a water activity of about 0.65 or less and a soft texture; wherein the food composition has a maximum compressive force of about 1 lbf or less; and
selecting among other ingredients to provide the food composition with one or more desirable properties including flavor, aroma, palatability, nutritional balance for an animal, total protein content, total carbohydrate content, total fat content, total caloric content, vitamin content, mineral content, stability, or shelf-life, thereby formulating a soft-textured food composition.

62. The method of claim 61 wherein the food composition so formulated does not comprise any antimicrobial additives.

63. The method of claim 62 wherein the food composition so formulated comprises about 5% to about 10% HMP fats, about 15% to about 25% humectants, about 8% to about 16% gelling agents, about 4% to about 12% water, and a water activity of about 0.50 to about 0.60.

64. The method of claim 61 wherein the HMP fats have an average melting point of about 50° C. or more.

65. The method of claim 61 wherein the humectants include one or more of glycerin, a monosaccharide, a disaccharide, a sugar alcohol, or a polysaccharide.

66. The method of claim 61 wherein the gelling agents include one or more of a modified starch, an agar, a pectin, or an edible gum.

67. A kit comprising in separate containers in a single package or in separate containers in a virtual package, as appropriate for the kit component, an edible composition comprising (1) one or more high melting point fats, (2) one or more humectants, and (3) one or more gelling agents, wherein the composition has a water content of about 16% or less and a water activity of about 0.65 or less, and at least one of (1) instructions for administering the composition to an animal, (2) instructions for one or more methods of using the composition for the benefit of an animal, (3) information on providing proper nutrition, including the composition, to the animal, (4) information about antimicrobials, or (5) comparative information or test results regarding the composition.

68. The kit of claim 67 wherein the edible composition has a soft texture such that the maximum compressive break force is about 1 lbf or less when measured using an Instron device.

69. The kit of claim 68 wherein the edible composition comprises no added antimicrobial additives.

70. The kit of claim 69 wherein the edible composition is formulated for a companion animal.

71. The kit of claim 70 wherein the companion animal is a dog or a cat.

72. A means for communicating information about, or instruction for use of, a composition comprising (1) one or more high melting point fats, (2) one or more humectants, (3) one or more gelling agents, wherein the composition has a water content of about 16% or less and a water activity of about 0.65 or less, wherein the information is about, or the instructions are for, one or more of:
(1) instructions for administering the composition to an animal;
(2) instructions for one or more methods of using the composition for the benefit of an animal;
(3) information on providing proper nutrition, including the composition, to the animal;
(4) information about antimicrobials; or
(5) comparative information or test results regarding the composition;
wherein the means of communicating comprises a physical or electronic document, digital storage media, optical storage media, audio presentation, audiovisual display, or visual display containing the information or instructions.

73. The means of claim 72 selected from the group consisting of a displayed web site, visual display kiosk, brochure, product label, package insert, advertisement, handout, public announcement, audiotape, videotape, DVD, CD-ROM, computer readable chip, computer readable card, computer readable disk, USB device, FireWire device, computer memory, and any combination thereof.

74. A method of manufacturing a food composition comprising (1) one or more high melting point fats, (2) one or more humectants, and (3) one or more gelling agents; wherein the composition contains less than about 16% water and a water activity of about 0.65 or less, the method comprising combining the high melting point fats, humectants, gelling agents, and water with other ingredients to form a mixture; cooking the mixture, and forming the cooked mixture into a desired size and shape.
